(19) United States
(12) Patent Application Publication
(10) Pub. No.: US 2024/0192362 A1
(43) Pub. Date: Jun. 13, 2024

(54) SIGNAL PROCESSING DEVICE, SOUND WAVE SYSTEM, AND VEHICLE

(71) Applicant: ROHM CO., LTD., Kyoto (JP)

(72) Inventor: Shogo TAKAMURA, Kyoto (JP)

(21) Appl. No.: 18/585,459

(22) Filed: Feb. 23, 2024

Related U.S. Application Data
(63) Continuation of application No. PCT/JP2022/025241, filed on Jun. 24, 2022.

(30) Foreign Application Priority Data
Aug. 25, 2021 (JP) 2021-136761

(51) Int. Cl. G01S 15/32; G01S 15/58; G01S 15/931

(52) U.S. Cl. CPC G01S 15/32; G01S 15/586; G01S 15/931

(57) ABSTRACT

A signal processing device includes a wave-transmission signal generator configured to generate a wave-transmission signal for wave transmission of a sound wave, and to include a first chirp signal and a second chirp signal in the wave-transmission signal, a wave-reception signal output unit configured to output a wave-reception signal based on reception of a sound wave, and a derivation unit configured to derive a relative speed with respect to a target object based on a first timing, at which part of the wave-reception signal corresponding to the first chirp signal is detected, and a second timing, at which part of the wave-reception signal corresponding to the second chirp signal is detected. One of the first and second chirp signals has a frequency that increases with time, and the other of the first and second chirp signals has a frequency that decreases with time.

### CROSS-REFERENCE TO RELATED APPLICATIONS

This nonprovisional application is a continuation application of International Patent Application No. PCT/JP2022/025241 filed on Jun. 24, 2022, which claims priority Japanese Patent Application No. 2021-136761 filed in Japan on Aug. 25, 2021, the entire contents of which are hereby incorporated by reference.

### BACKGROUND OF THE INVENTION

### 1. Technical Field

The invention disclosed herein relates to a signal processing device that processes a wave-transmission signal for wave transmission of sound wave and a wave-reception signal that is based on wave reception of a sound wave, a sound wave system including the signal processing device, and a vehicle including the sound wave system.

### 2. Description of Related Art

Conventionally, there is known an ultrasonic system that determines a distance to a target object (an obstacle) by generating an ultrasonic wave and counting a TOF (Time Of Flight) taken until a reflected wave of the ultrasonic wave returns (see, for example, WO2020/004609). Such an ultrasonic system is often installed in a vehicle, and one of its known examples is a clearance sonar for use in vehicles.

### BRIEF DESCRIPTION OF THE DRAWINGS

FIG. 1 is a diagram schematically showing a vehicle in which a sound wave system according to an embodiment is installed, and a target object.

FIG. 2 is a diagram for illustrating an example of correlation processing.

FIG. 3 is a diagram for illustrating an example of correlation processing.

FIG. 4 is a diagram showing a configuration of an ultrasonic system according to the embodiment.

FIG. 5 is a diagram showing an example of a wave-transmission control signal.

FIG. 6 is a diagram schematically showing an example of a wave-reception signal.

FIG. 7 is a diagram showing an example of a first reflected-wave detection unit.

FIG. 8 is a time chart showing a result of correlation processing.

### DESCRIPTION OF EMBODIMENTS

Hereinafter, an embodiment will be described with reference to the accompanying drawings. Note that an ultrasonic system according to the embodiment described below is designed to be installed in a vehicle as an example, and can be used for an alarm function, an automatic braking function, an automatic parking function, and the like, which are achieved by measuring a distance between the vehicle and a target object.

### <Correlation Processing>

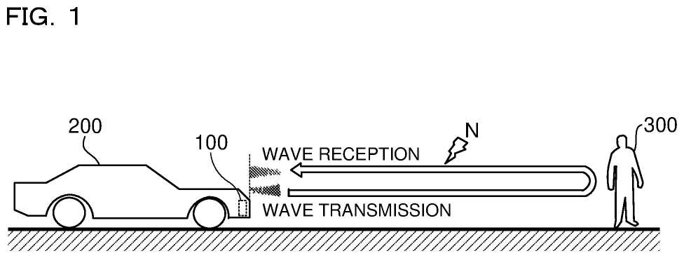

First, a description will be given of an outline of correlation processing used in the ultrasonic system according to the embodiment. FIG. 1 shows a vehicle 200 having installed therein an ultrasonic system 100 (hereinafter, referred to as “the ultrasonic systems 100”) according to the embodiment, and a target object (obstacle) 300. An ultrasonic wave transmitted from the ultrasonic system 100 is reflected on the target object 300 to be received as a reflected wave by the ultrasonic system 100. At this time, the ultrasonic system 100 also receives environmental noise N.

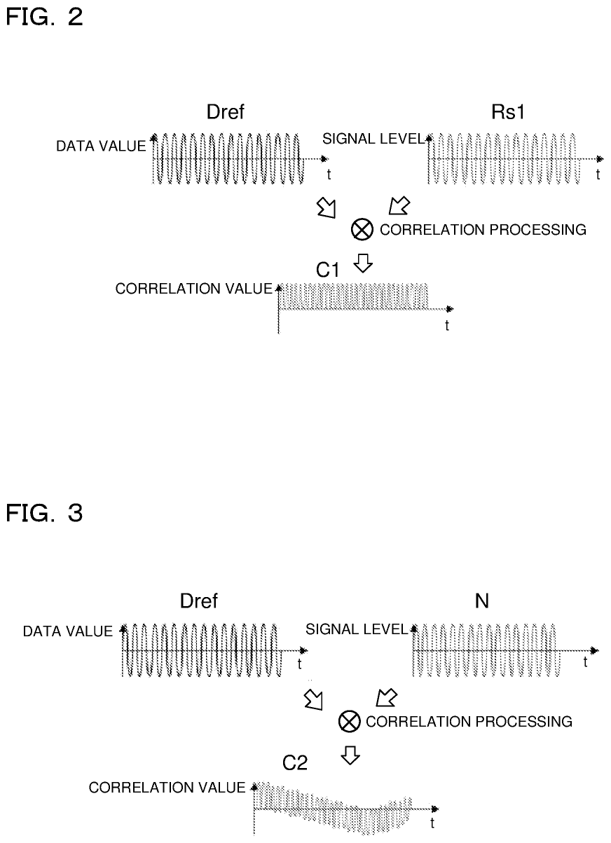

Here, the correlation processing will be described with reference to FIGS. 2 and 3. In FIG. 2, reference data Dref is prepared in advance. The reference data Dref is waveform data of a reflected wave expected to be received, and hence is data of a waveform having the same frequency as a transmitted sound wave. A reflected wave Rs1 shown in FIG. 2 has a frequency identical to that of the transmitted sound wave. Accordingly, in a correlation result C1 obtained by correlation processing in which the reference data Dref and the reflected wave Rs1 are multiplied together, a correlation value is always a positive value as shown in FIG. 2. As a result, a convolution integral value obtained by integrating the correlation result C1 with respect to time is large, so that the reflected wave is emphasized.

On the other hand, the frequency of environmental noise N shown in FIG. 3 is deviated from the transmitted wave frequency. That is, the frequency of the environmental noise N deviates from the frequency of the reference data Dref. Thus, as shown in FIG. 3, in a correlation result C2, the correlation value is negative in a period, and as a result, the convolution integral value is smaller than in FIG. 2. In this manner, a reflected wave based on wave transmission can be distinguished from environmental noise.

### <Ultrasonic System>

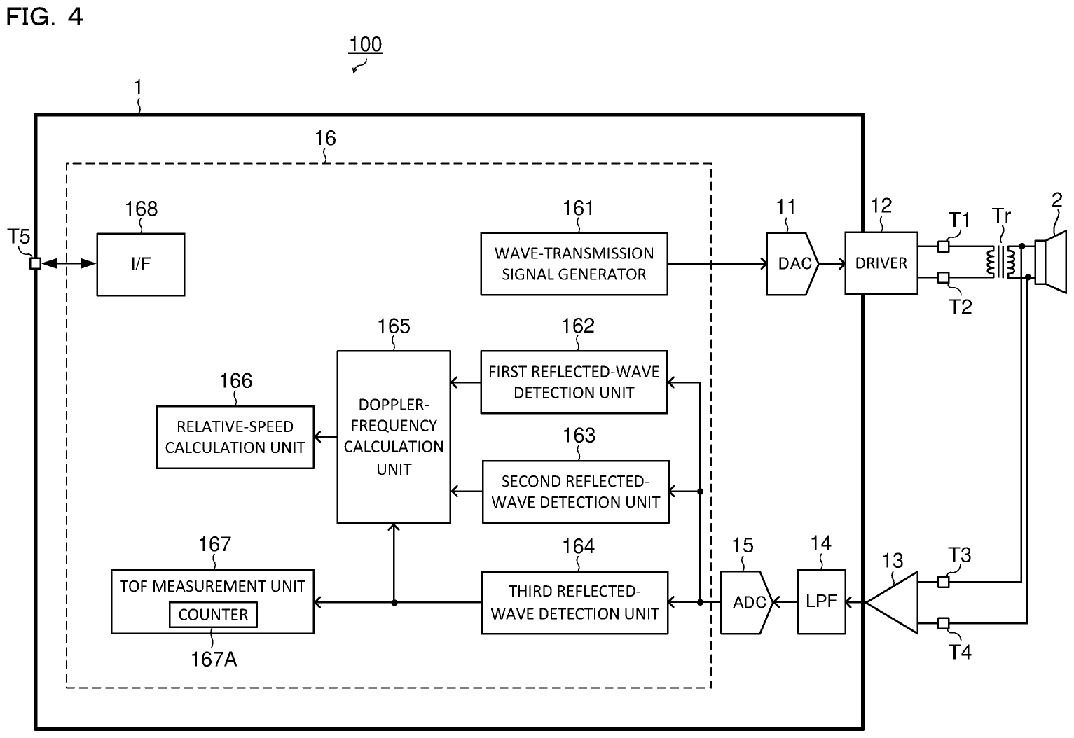

Next, the ultrasonic system 100 will be described. FIG. 4 is a diagram showing a configuration of the ultrasonic system 100.

The ultrasonic system 100 includes a signal processing device 1, a transformer Tr, and an ultrasonic transmission reception device 2. The ultrasonic transmission reception device 2 is externally connected to the signal processing device 1 via the transformer Tr. Note that the transformer Tr is not necessarily essential.

The signal processing device 1 is a semiconductor integrated circuit device. The signal processing device 1 includes a DAC (Digital to Analog Converter) 11, a driver 12, an LNA (Low Noise Amplifier) 13, an LPF (Low Pass Filter) 14, an ADC (Analog to Digital Converter) 15, a digital processing unit 16, and external terminals T1 to T5.

The DAC 11 performs digital-to-analog conversion on a wave-transmission signal output from a wave-transmission signal generator 161 included in the digital processing unit 16, and outputs a signal resulting from the analog-to-digital conversion to the driver 12.

A pair of differential output terminals of the driver 12 are connected to a primary side of the transformer Tr via the external terminals T1 and T2. To a secondary side of the transformer Tr, the ultrasonic transmission reception device 2 is connected. The driver 12, based on an output signal of the DAC 11, drives the ultrasonic transmission reception device 2.

The ultrasonic transmission reception device 2 includes an unillustrated piezoelectric element, and transmits and receives an ultrasonic wave. That is, the ultrasonic transmission reception device 2 functions both as a sound source and as a receiver.

A pair of differential input terminals of the LNA 13 are connected to the secondary side of the transformer Tr via the external terminals T3 and T4. An output signal of the LNA 13 is fed via the LPF 14 to the ADC 15. The ADC 15 performs analog-to-digital conversion on the output signal of the LNA 13 to convert it from an analog signal to a digital signal, and outputs the digital signal to a first reflected-wave detection unit 162, a second reflected-wave detection unit 163, and a third reflected-wave detection unit 164, which are included in the digital processing unit 16.

The LNA 13, the LPF 14, and the ADC 15 are an example of a wave-reception signal output unit configured to output a wave-reception signal based on wave reception of an ultrasonic wave.

The digital processing unit 16 includes the wave-transmission signal generator 161, the first reflected-wave detection unit 162, the second reflected-wave detection unit 163, the third reflected-wave detection unit 164, a Doppler-frequency calculation unit 165, a relative-speed calculation unit 166, a TOF measurement unit 167, and an interface 168.

The wave-transmission signal generator 161 is configured to generate a wave-transmission signal for wave transmission of an ultrasonic wave. More specifically, on receiving a wave-transmission command from an unillustrated ECU (Electronic Control Unit) mounted on the vehicle 200 (see FIG. 1) via the interface 168, the wave-transmission signal generator 161 generates a wave-transmission signal and outputs the wave-transmission signal to the DAC 11.

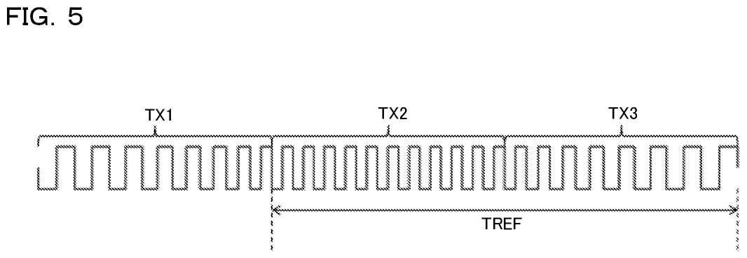

The wave-transmission signal generator 161 is configured to include, in a wave-transmission control signal, a first chirp signal TX1, a constant-frequency signal TX2, and a second chirp signal TX3, which are all illustrated in FIG. 5, in order of the first chirp signal TX1, the constant-frequency signal TX2, and the second chirp signal TX3. The wave-transmission signal generator 161 is configured to generate a wave-transmission signal based on the wave-transmission control signal. The wave-transmission signal has a waveform substantially similar to that of the wave-transmission control signal except for a slant due to effects of circuit response and the like.

In the example shown in FIG. 5, the first chirp signal TX1 is an 8-wave chirp signal having a frequency increasing in 1-kHz increments from 53 kHz to 60 kHz, the constant-frequency signal TX2 is an 11-wave signal having a frequency of 60 kHz, and the second chirp signal TX3 is an 8-wave signal having a frequency decreasing in 1-kHz increments from 60 kHz to 53 kHz. Note that the frequency and the number of waves of the wave-transmission control signal are not limited to the example shown in FIG. 5.

However, it is desirable that the frequency variation width of the first chirp signal TX1 be identical to that of the second chirp signal TX3. If the frequency variation width of the first chirp signal TX1 and that of the second chirp signal TX3 are identical, the frequency variation width of the wave-transmission signal as a whole can be minimized. This helps simplify the processes of circuit designing and component selection.

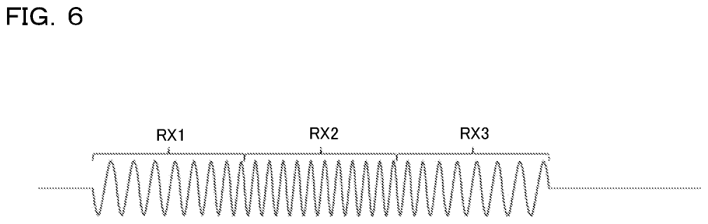

The first reflected-wave detection unit 162, based on the correlation between the wave-reception signal output from the ADC 15 and first reference data constituted of the first chirp signal TX1, detects a part RX1 (see FIG. 6) that corresponds to the first chirp signal of the wave-reception signal.

The second reflected-wave detection unit 163, based on the correlation between the wave-reception signal output from the ADC 15 and second reference data constituted of the second chirp signal TX3, detects a part RX3 (see FIG. 6) that corresponds to the second chirp signal of the wave-reception signal.

The third reflected-wave detection unit 164, based on the correlation between the wave-reception signal output from the ADC 15 and third reference data constituted of the first chirp signal TX1, the constant-frequency signal TX2, and the second chirp signal TX3, detects a part RX3 (see FIG. 6) that corresponds to the second chirp signal of the wave-reception signal.

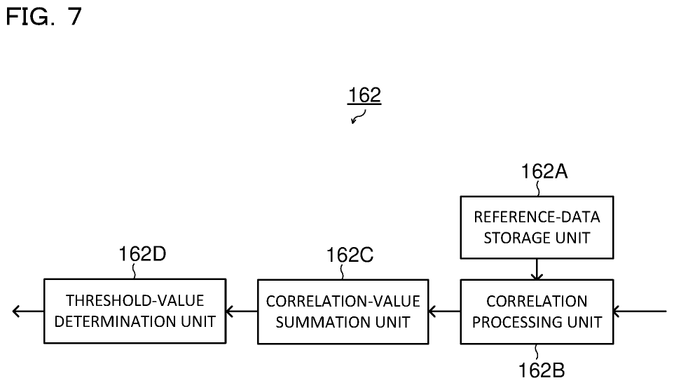

FIG. 7 is a diagram showing an example of the first reflected-wave detection unit 162. The first reflected-wave detection unit 162 of the example shown in FIG. 7 includes a reference-data storage unit 162A, a correlation processing unit 162B, a correlation-value summation unit 162C, and a threshold-value determination unit 162D. The reference-data storage unit 162A is configured to store the first reference data therein. As the reference-data storage unit 162A, a register can be used, for example.

The correlation processing unit 162B performs correlation processing, at a predetermined cycle, based on the wave-reception signal output from the ADC 15 and the first reference data stored in the reference-data storage unit 162A.

The correlation-value summation unit 162C sums up results of the correlation processing performed by the correlation processing unit 162B to thereby output a correlation convolution integral value. Note that, as the correlation convolution integral value to be output, a calculated result that is a negative value may be truncated to zero.

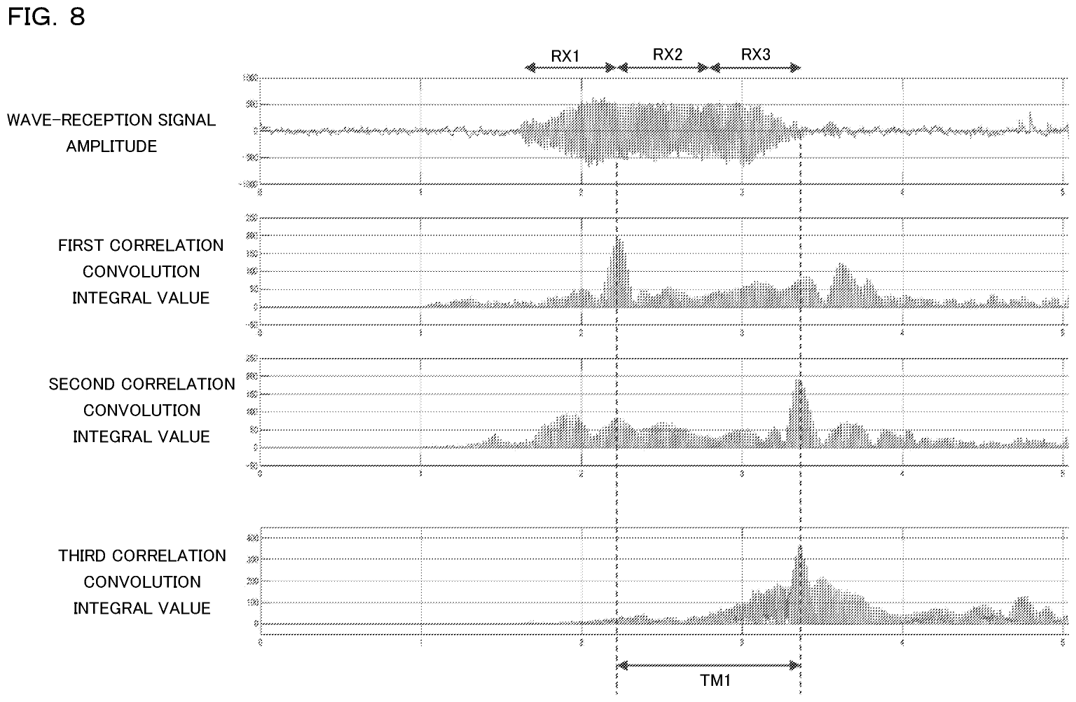

The threshold-value determination unit 162D compares the correlation convolution integral value with a predetermined threshold value. As shown in FIG. 8, the threshold-value determination unit 162D, when the correlation convolution integral value is larger than the predetermined threshold value and is also at its local maximum, detects the part RX1 (see FIG. 6) that corresponds to the first chirp signal of the wave-reception signal.

An example of the second reflected-wave detection unit 163 and an example of the third reflected-wave detection unit 164 are similar to the example of the first reflected-wave detection unit 162. However, in the second reflected-wave detection unit 163, the second reference data is used instead of the first reference data, and in the third reflected-wave detection unit 164, the third reference data is used instead of the first reference data. Further, in the example of the second reflected-wave detection unit 163 and in the example of the third reflected-wave detection unit 164, instead of the part RX1 (sec FIG. 6) corresponding to the first chirp signal of the wave-reception signal, the part RX3 (sec FIG. 6) corresponding to the second chirp signal of the wave-reception signal is detected.

The Doppler-frequency calculation unit 165 includes a storage unit (unillustrated) that stores therein a time TREF that is from a first end timing at which the first chirp signal TX1 of the wave-transmission signal ends until a second end timing at which the second chirp signal TX3 of the wave-transmission signal ends. The Doppler-frequency calculation unit 165 measures a time TM1 (FIG. 8) that is from a first timing at which the part RX1 corresponding to the first chirp signal of the wave-reception signal has been detected until a second timing at which the part RX3 corresponding to the second chirp signal of the wave-reception signal has been detected. The Doppler-frequency calculation unit 165 may incorporate a counter to measure the time TM1 with the counter, or may measure the time TM1 using a counter 167A in the TOF measurement unit 167.

Note that, in a case where the part RX3 corresponding to the second chirp signal of the wave-reception signal is detected by only one of the second reflected-wave detection unit 163 and the third reflected-wave detection unit 164, it is desirable for the Doppler-frequency calculation unit 165 not to measure the time TM1, determining that the part RX3 corresponding to the second chirp signal of the wave-reception signal has not been detected. This helps suppress erroneous measurement of the time TM1. Further, it is desirable for the Doppler-frequency calculation unit 165 not to measure the time TM1 also in a case where there is a time lag of a predetermined time period or longer between a detection timing at which the second reflected-wave detection unit 163 has detected the part RX3 corresponding to the second chirp signal of the wave-reception signal and a detection timing at which the third reflected-wave detection unit 164 has detected the part RX3 corresponding to the second chirp signal of the wave-reception signal. This helps suppress erroneous measurement of the time TM1.

In a case where there is a time lag, though the time lag is shorter than the predetermined time period, between the detection timing at which the second reflected-wave detection unit 163 has detected the part RX3 corresponding to the second chirp signal of the wave-reception signal and the detection timing at which the third reflected-wave detection unit 164 has detected the part RX3 corresponding to the second chirp signal of the wave-reception signal, the Doppler-frequency calculation unit 165 may use one of them for the measurement of the time TM1, or may use the average of them for the measurement of the time TM1.

The Doppler-frequency calculation unit 165 calculates a Doppler frequency of the wave-reception signal from a difference between the time TREF and the time TM1.

The relative-speed calculation unit 166 calculates a relative speed between the vehicle 200 (see FIG. 1) and the target object 300 (see FIG. 1) from the Doppler frequency of the wave-reception signal calculated by the Doppler-frequency calculation unit 165.

The first reflected-wave detection unit 162, the second reflected-wave detection unit 163, the third reflected-wave detection unit 164, the Doppler-frequency calculation unit 165, and the relative-speed calculation unit 166, of which all have been described above, constitute an example of a derivation unit configured to derive a relative speed with respect to the target object 300 (see FIG. 1) based on the first timing at which the part RX1 (see FIGS. 6 and 8) corresponding to the first chirp signal of the wave-reception signal is detected and the second timing at which the part RX3 (see FIGS. 6 and 8) corresponding to the second chirp signal of the wave-reception signal is detected.

The TOF measurement unit 167 uses the counter 167A to measure a time (TOF) from when an ultrasonic wave is transmitted until when a reflected wave of the ultrasonic wave reflected from the target object 300 is received. Note that, in the present embodiment, the TOF measurement unit 167 stops the counting operation of the counter 167A according to the detection result of the third reflected-wave detection unit 164, but, instead of the detection result of the third reflected-wave detection unit 164, the detection result of the second reflected-wave detection unit 163 may be used, or the detection result of the third reflected-wave detection unit 164 and the detection result of the second reflected-wave detection unit 163 may be used instead.

The interface 168 is compliant with LIN (Local Interconnect Network) as an example, and performs communication via the external terminal T5 with the unillustrated ECU mounted on the vehicle 200 (see FIG. 1). For example, the interface 168 transmits the calculation result of the relative-speed calculation unit 166 and the measurement result of the TOF measurement unit 167 to the unillustrated ECU mounted on the vehicle 200 (see FIG. 1).

### <Others>

Note that the present invention can be implemented with any other configuration than those of the embodiment described above, with various modifications made without departure from the spirit of the present invention. It should be understood that the foregoing embodiment is not limitative but illustrative in every respect. The technical scope of the present invention is not determined by the foregoing embodiment but by the claims, and should be construed to include all modifications equivalent in meaning and scope to the claims.

For example, the wave-transmission signal does not need to include the constant-frequency signal TX2. However, if the wave-transmission signal includes the constant-frequency signal TX2, the third reflected-wave detection unit 164 can perform the detection with improved accuracy, and thus it is desirable for the wave-transmission signal to include the constant-frequency signal TX2.

Further, for example, instead of the second reference data or the third reference data described above, reference data constituted of the constant-frequency signal TX2 and the second chirp signal TX3 may be used.

Further, for example, in the wave-transmission signal, the order of the first chirp signal TX1 and the second chirp signal TX3 may be switched.

In the above embodiment, the ultrasonic system 100 has been described which transmits an ultrasonic wave (a wave of sound having a frequency higher than audible sound), but the present invention is applicable also to a sound wave system that transmits a sound wave other than an ultrasonic wave.

As described above, a signal processing device (1) includes a wave-transmission signal generator (161) configured to generate a wave-transmission signal for wave transmission of a sound wave and to include a first chirp signal and a second chirp signal in the wave-transmission signal, a wave-reception signal output unit (13, 14, 15) configured to output a wave-reception signal based on reception of a sound wave, and a derivation unit (162, 163, 164, 165, 166) configured to derive a relative speed with respect to a target object based on a first timing, at which part of the wave-reception signal corresponding to the first chirp signal is detected, and a second timing, at which part of the wave-reception signal corresponding to the second chirp signal is detected. Here, one of the first chirp signal and the second chirp signal has a frequency that increases with time, and the other of the first chirp signal and the second chirp signal has a frequency that decreases with time (a first configuration).

The signal processing device having the above first configuration is capable of measuring a relative speed with respect to a target object.

In the signal processing device having the above first configuration, the derivation unit may be configured to derive the relative speed based on a result of comparison between a time from a first end timing, at which the first chirp signal of the wave-transmission signal ends, until a second end timing, at which the second chirp signal of the wave-transmission signal ends, and a time from the first timing until the second timing (a second configuration).

The signal processing device having the above second configuration is capable of calculating a relative speed with respect to a target object from a Doppler frequency of a wave-reception signal.

In the signal processing device having the above first or second configuration, the wave-transmission signal generator may be configured to include, in the wave-transmission signal, the first chirp signal, a constant-frequency signal, and the second chirp signal in order of the first chirp signal, the constant-frequency signal, and the second chirp signal (a third configuration).

The signal processing device having the above third configuration is capable of improving the accuracy of a relative speed with respect to a target object.

In the signal processing device having any one of the above first to third configurations, the derivation unit may be configured to detect, based on a correlation between the wave-reception signal and each of a plurality of pieces of reference data, part of the wave-reception signal corresponding to the second chirp signal (a fourth configuration).

The signal processing device having the above fourth configuration is capable of suppressing erroneous measurement of a relative speed with respect to a target object.

In the signal processing device having any one of the above first to fourth configurations, a frequency variation width of the first chirp signal may be identical to a frequency variation width of the second chirp signal (a fifth configuration).

The signal processing device having the above fifth configuration is capable of minimizing a frequency variation width of a wave-transmission signal as a whole. This helps simplify the processes of circuit designing and selecting components.

As described above, a sound wave system (100) includes the signal processing device having any one of the above first to fifth configurations, and a sound-wave transmission reception device (2) configured to be directly or indirectly connected to the signal processing device (a sixth configuration).

The sound wave system having the above sixth configuration is capable of measuring a relative speed with respect to a target object.

As described above, a vehicle (200) includes the sound wave system having the above sixth configuration (a seventh configuration).

The vehicle having the above seventh configuration is capable of using a relative speed with respect to a target object measured by the sound wave system.

What is claimed is:

1. A signal processing device, comprising:
a wave-transmission signal generator configured to generate a wave-transmission signal for wave transmission of a sound wave, and to include a first chirp signal and a second chirp signal in the wave-transmission signal;
a wave-reception signal output unit configured to output a wave-reception signal based on reception of a sound wave; and
a derivation unit configured to derive a relative speed with respect to a target object based on a first timing, at which part of the wave-reception signal corresponding to the first chirp signal is detected, and a second timing, at which part of the wave-reception signal corresponding to the second chirp signal is detected,
wherein
one of the first chirp signal and the second chirp signal has a frequency that increases with time, and the other of the first chirp signal and the second chirp signal has a frequency that decreases with time.

2. The signal processing device according to claim 1,
wherein
the derivation unit is configured to derive the relative speed based on a result of comparison between a time from a first end timing, at which the first chirp signal of the wave-transmission signal ends, until a second end timing, at which the second chirp signal of the wave-transmission signal ends, and a time from the first timing until the second timing.

3. The signal processing device according to claim 1,
wherein
the wave-transmission signal generator is configured to include, in the wave-transmission signal, the first chirp signal, a constant-frequency signal, and the second chirp signal in order of the first chirp signal, the constant-frequency signal, and the second chirp signal.

4. The signal processing device according to claim 1,
wherein
the derivation unit is configured to detect, based on a correlation between the wave-reception signal and each of a plurality of pieces of reference data, part of the wave-reception signal corresponding to the second chirp signal.

5. The signal processing device according to claim 1,
wherein
a frequency variation width of the first chirp signal is identical to a frequency variation width of the second chirp signal.

6. A sound wave system, comprising:
the signal processing device according to claim 1; and
a sound-wave transmission reception device configured to be directly or indirectly connected to the signal processing device.

7. A vehicle, comprising the sound wave system according to claim 6.
